(19) United States
(12) Patent Application Publication
(10) Pub. No.: US 2020/0278238 A1
(43) Pub. Date: Sep. 3, 2020

(54) SENSING PAD

(71) Applicant: Smarter Applications Limited

(72) Inventors: Christian Lane, Tadworth (GB); Isabella Lane, Tadworth (GB)

(21) Appl. No.: 16/068,035

(22) PCT Filed: Jan. 3, 2017
(86) PCT No.: PCT/GB2017/050002

§ 371 Date: Jul. 3, 2018

(30) Foreign Application Priority Data
Jan. 4, 2016 (GB) 1600104.2

(51) Int. Cl. G01G 19/42; G06Q 10/08

(52) U.S. Cl. CPC G01G 19/42; G06Q 10/087

(57) ABSTRACT

A sensing pad configured to detect an object on a surface of the pad, said surface being configured into multiple zones, and determine in which zone the detected object is located in order that the detected object can be associated with an object type that is associated with the determined zone.

This invention relates to a method and apparatus for assisting with stock control.

There has been an explosion of interest in introducing wireless capability into everyday devices following the advent of the internet of things. In many instances, manufacturers have responded to this upsurge of interest by simply introducing wireless chips into domestic appliances or similar. For the user, however, this wireless capability is not always readily accessible or practically useable. Many users would like to take advantage of the new technology to make their lives easier, but they have neither the technical capability nor the money to replace their existing kitchen with a new “smart” kitchen. Therefore, there is a need for products that can introduce intelligence into people's homes in a practical way.

According to one aspect, there is provided a sensing pad configured to detect an object on a surface of the pad, said surface being configured into multiple zones, and determine in which zone the detected object is located in order that the detected object can be associated with an object type that is associated with the determined zone.

Other aspects may include one or more of the following.

The sensing pad may be associated with a controller that is configured to associate the detected object with the object type. It may comprise the controller. It may comprise a wireless transmitter, the sensing pad being configured to transmit data indicative of a detected object to the controller. The sensing pad may be configured to transmit data comprising one or more of an indication of the presence of the detected object, a weight of the detected object and the determined zone in which the detected object is located.

The sensing pad may be configured to detect when the presence of an object on the surface of the pad changes and to enter a low power mode if no changes occur for a predetermined length of time. It may comprise a sensor configured to detect movement in the vicinity of the sensing pad, the sensing pad being configured to wake from a low power mode if the sensor detects movement.

The sensing pad may comprise at least one presence sensor associated with each zone, the sensing pad being configured such that a presence sensor associated with one zone detects an object located in that zone but does not detect an object located in any of the other zones. It may comprise an upper mat and a lower mat and one or more presence sensors therebetween for detecting an object on the surface of the pad. It may comprise one or more guiding pins between the upper mat and the lower mat configured to assist the upper mat to deform uniformly across its surface responsive to an object on that surface. It may comprise one or more boundary strips that separate an upper mat of one zone from an upper mat of a neighbouring zone. The one or more boundary strips may be configured to prevent the upper mat of one zone from deforming responsive to an object on its neighbouring zone. At least one of the upper and lower mats may comprise a flexible material. At least one of the upper and lower mats may comprise an inflexible plate.

The sensing pad may comprise one or more weight sensors configured to detect the weight of an object on the surface of the pad. The weight sensors being configured to detect the weight such that said detected weight can be converted into a volume.

According to a second aspect, there is provided a controller comprising an input configured to receive data indicative of an object detected on a sensing pad and a stock control module configured to determine which zone, of multiple zones on the surface of the sensing pad, the detected object is located in and associate the detected object with an object type associated with the determined zone.

Other aspects may include one or more of the following.

The stock control module may be configured to determine a remaining amount of a comestible in dependence on the received data and the object type associated with the detected object. It may be configured to provide an indication of the remaining amount to a user in dependence on that remaining amount and/or a factor independent of the remaining amount. It may be configured to provide an indication of the remaining amount to a user in a format that is dependent on user preference. It may be configured to convert the received data into data of a different type in dependence on the object type associated with the detected object. It may be configured to determine the object type in dependence on one or more of user input, a product identification number, or a scan of an identification image marked on the object. The received data may include data indicative of a weight of the detected object, the stock control module may be configured to convert that weight into a volume in dependence on the object type associated with the detected object. The received data may include data indicative of a gross weight of the detected object, the stock control module may be configured to convert that gross weight into a net weight in dependence on the object type associated with the detected object.

The stock control module may be configured to identify a set of one of more object types linked to the object type with which the detected object is associated and provide that set of object types to a user. The set of one or more object types may correspond to ingredients in a recipe.

According to a third aspect, there is provided a method comprising detecting an object on a surface of a sensing pad, determining that said object is located in a particular zone of multiple zones formed from the surface of the sensing pad and associating the object with an object type associated with the determined zone.

According to a third aspect, there is provided machine readable code for implementing a controller and method as described herein.

According to a fourth aspect, there is provided a machine readable storage medium having encoded thereon non-transitory machine-readable code for implementing a controller and method as described herein.

The present invention will now be described by way of example with reference to the accompanying drawings. In the drawings:

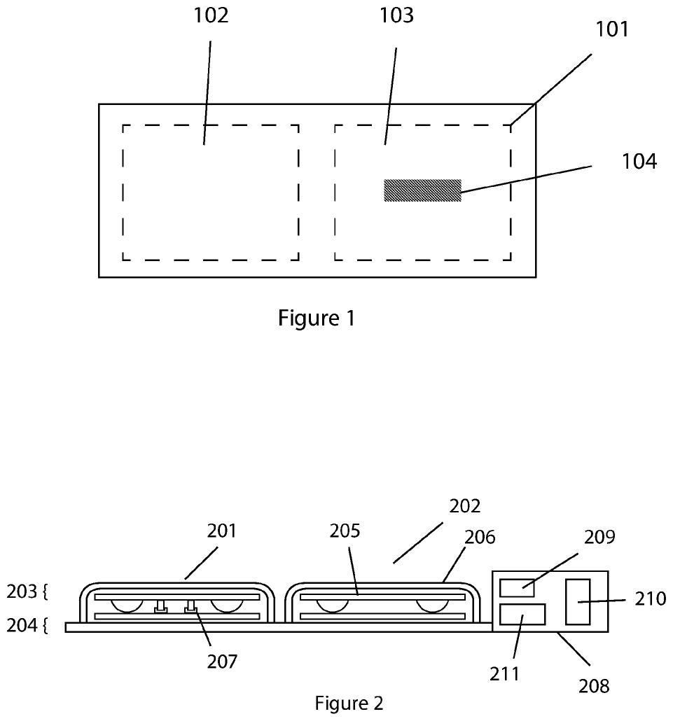

FIG. 1 shows an example of a sensing pad;

FIG. 2 shows an example of a sensing pad;

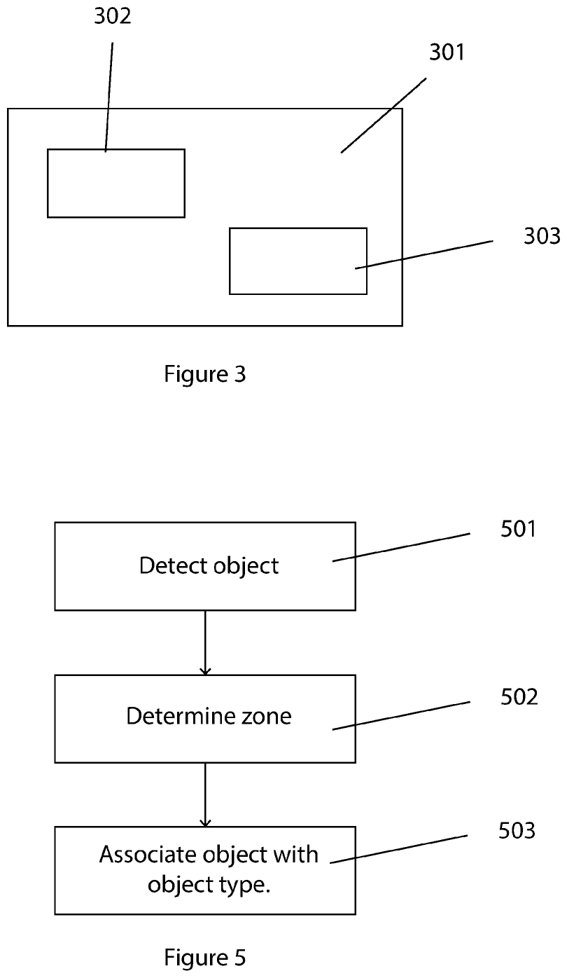

FIG. 3 shows a controller;

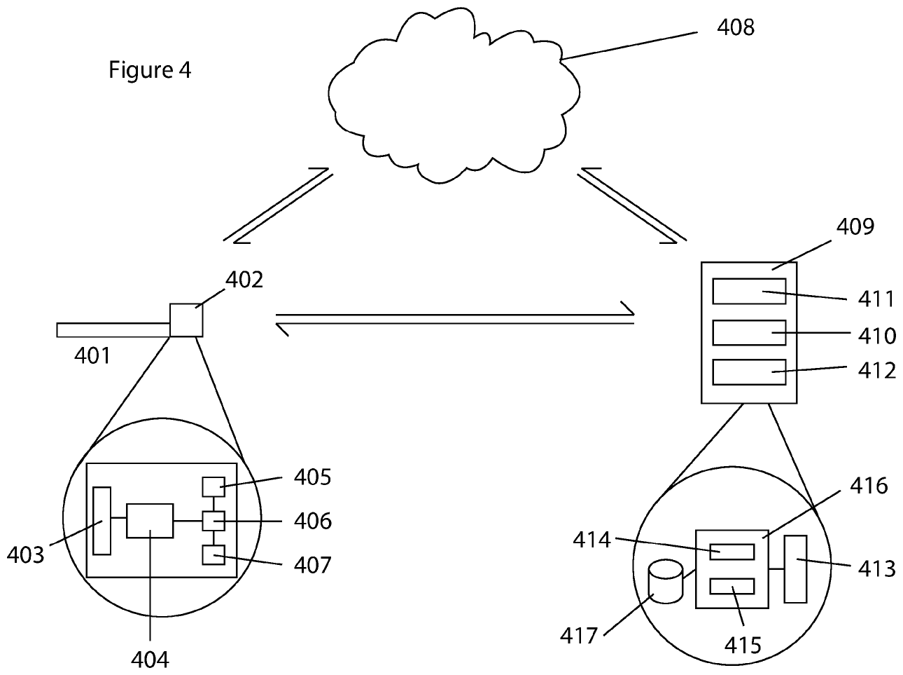

FIG. 4 shows an example in which the controller is implemented by a user device;

FIG. 5 shows an example of a method of stock control;

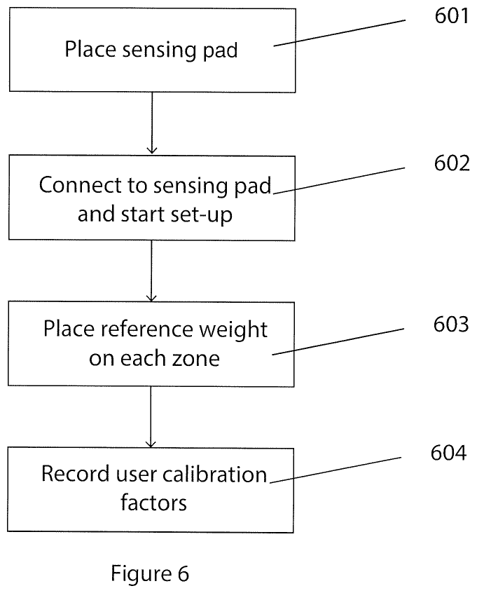

FIG. 6 shows an example of a method for setting up the sensing pad;

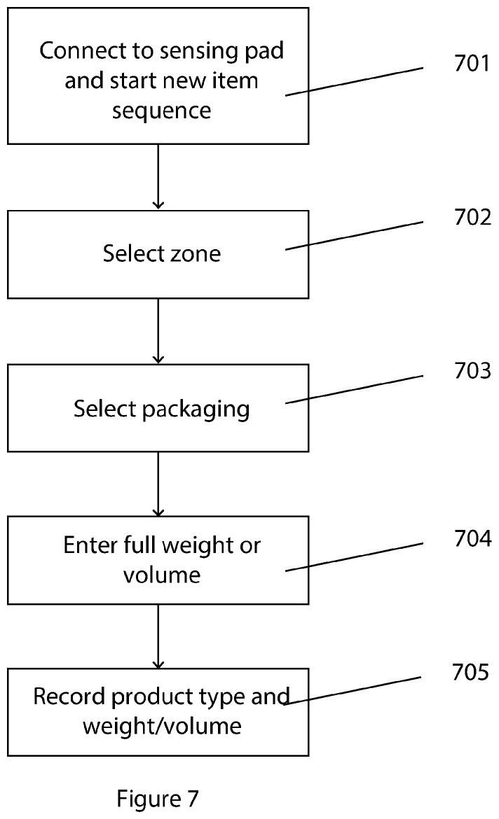

FIG. 7 shows an example of a method for adding a new item to the sensing pad;

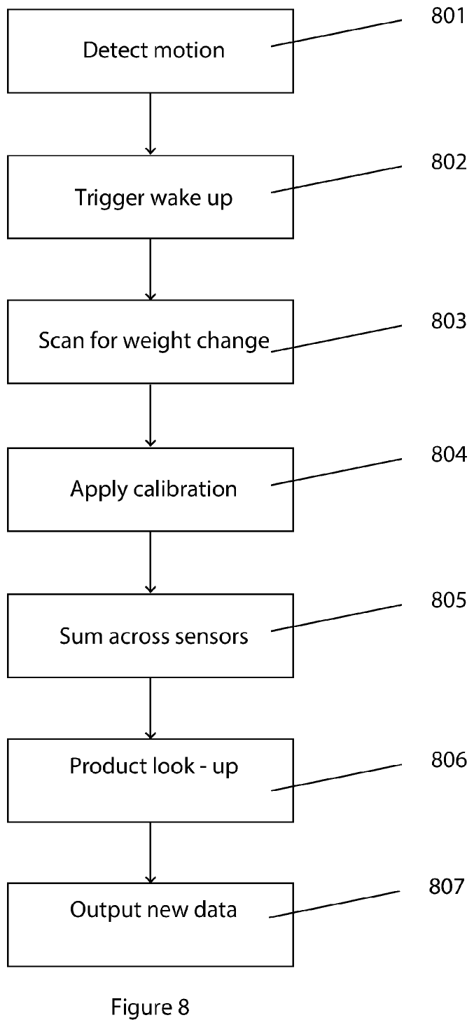

FIG. 8 shows an example of a typical method for using the sensing pad;

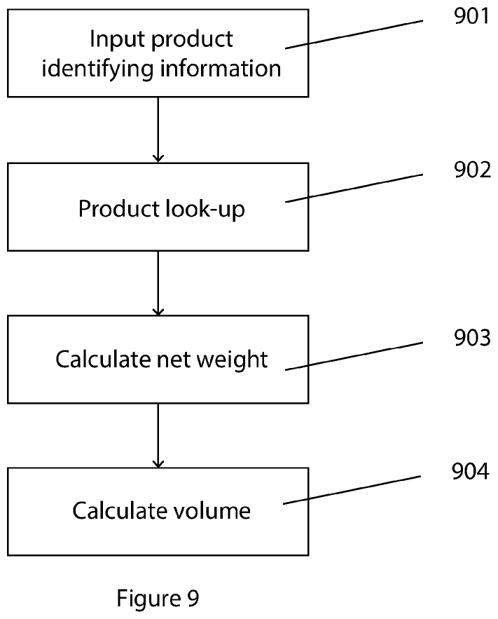

FIG. 9 shows an example of a method for converting a weight into volume in dependence on product type;

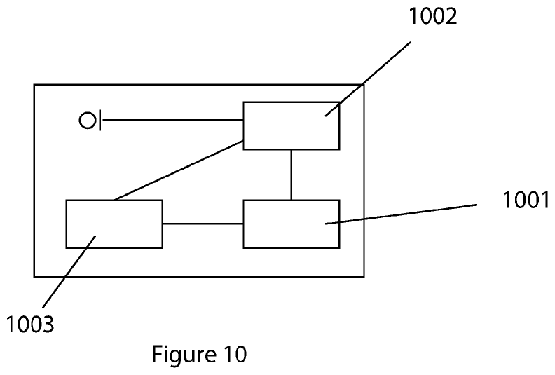

FIG. 10 shows an example of a sound detect unit;

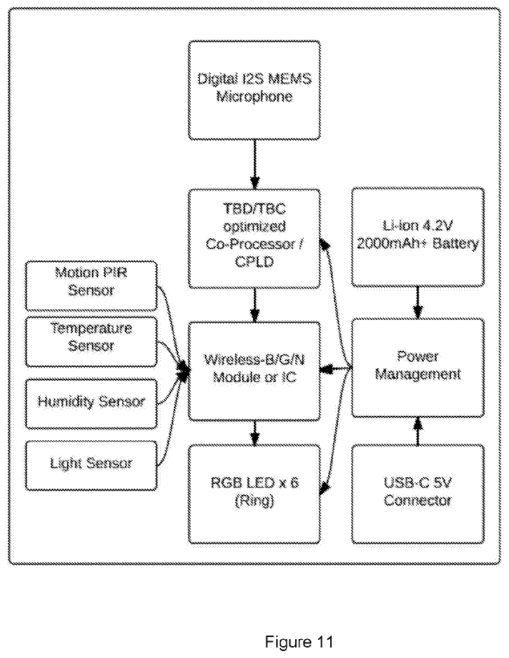

FIG. 11 shows an example of a sound detect unit;

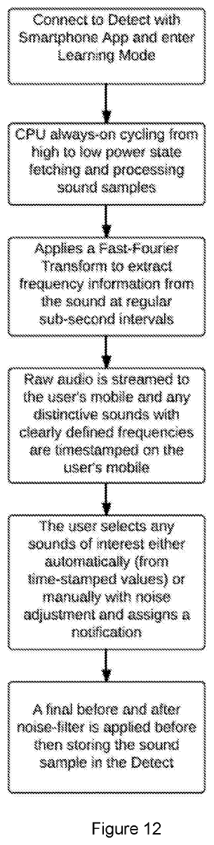

FIG. 12 shows an example of a method for a sound detect unit to “learn” sounds;

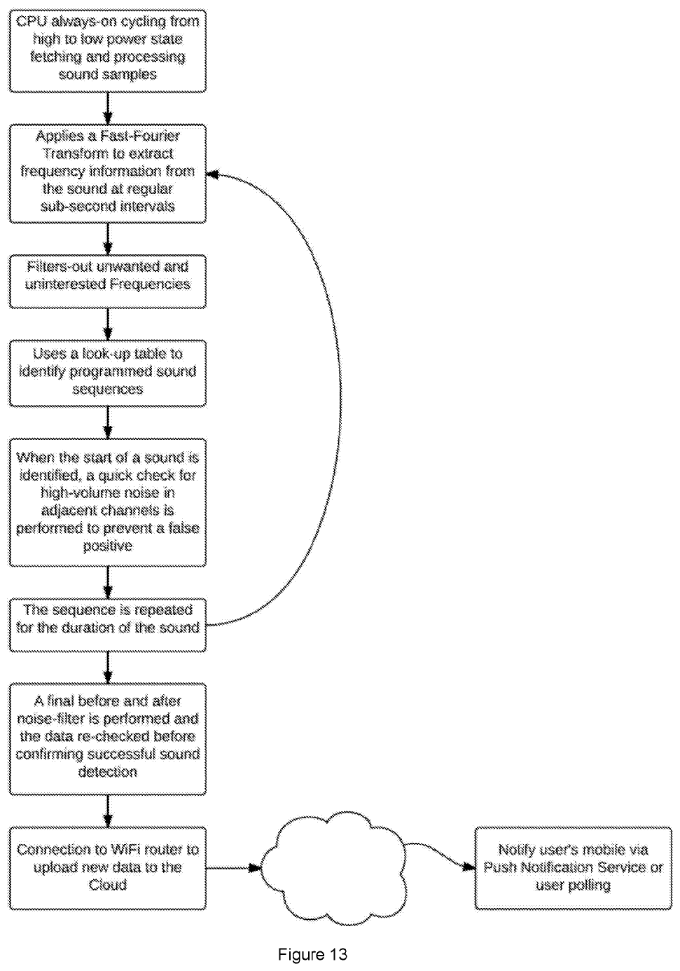

FIGS. 13 shows an example of a typical method for using the sound detect unit;

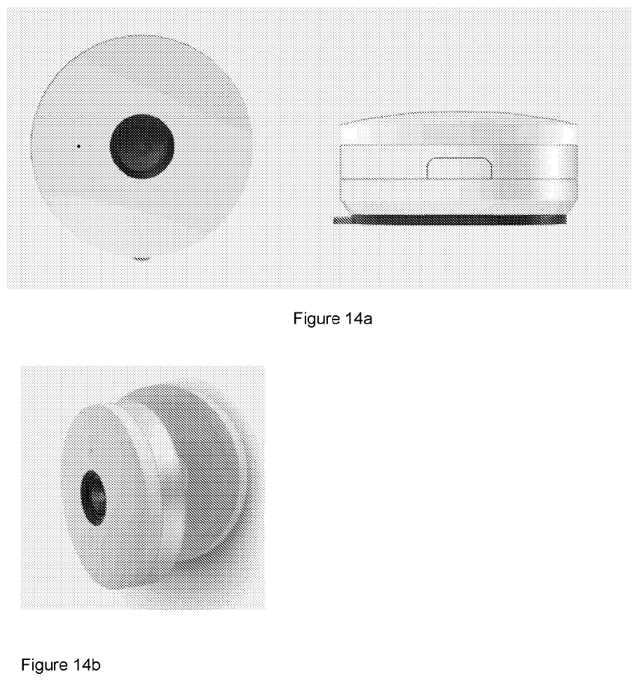

FIGS. 14a and b show outer views of a fridge camera;

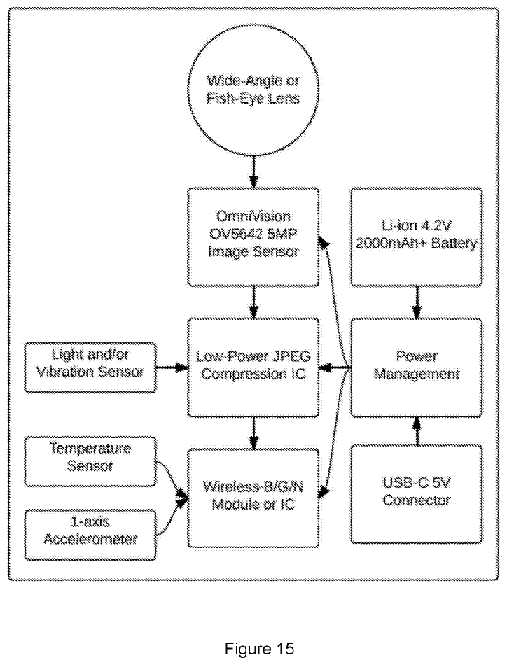

FIG. 15 shows an example of components within a fridge camera;

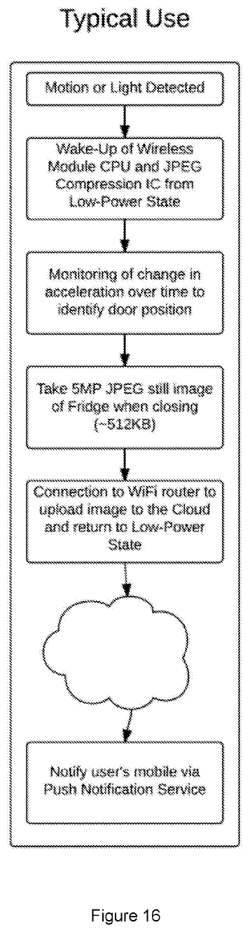

FIG. 16 shows an example of a typical method for using a fridge camera; and

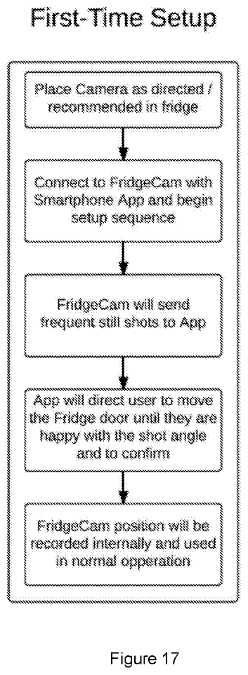

FIG. 17 shows an example of a method for setting up the fridge camera.

An example of one tool for introducing intelligence into an existing kitchen is shown in FIG. 1. The tool comprises a sensing pad, shown generally at 101. The pad in this example is divided into two zones 102, 103. In other examples the pad may be divided into more than two zones. The pad is able to detect if an object 104 is placed on its surface. It is also able to determine which zone that object is located in, which is zone 103 in this example. This is useful because it enables the object to be associated with a particular category in dependence on the pad zone. Suitably that category designates the object as being of a particular type. For kitchen applications, that object type may be linked to a particular category or type of foodstuff. Categories could include general designations such as vegetables, condiments or dairy. Categories might be more specific, such as carrots, vinegar or cheese. The object type associated with each zone may be set by the user.

A more detailed example of a sensing pad is shown in FIG. 2. The pad comprises two zones, 201 and 202. Each zone comprises a respective upper mat 203 and a lower mat 204. In this example, each mat is formed from a relatively inflexible plate 205 together with a flexible covering 206. Each zone also includes a number of sensors 207. The sensors could be any suitable pressure or weight sensor, for example, force-sensitive resistors (FSR) or quantum tunnelling composites (QTC).

When an object is placed on the upper mat it deforms slightly, creating pressure on the sensors. This causes the sensors to output a pressure or weight reading. The number of sensors is suitably selected in dependence on the surface area of the zone. A typical number might be three or four sensors per zone. The sensors are preferably evenly distributed throughout the zone. The sensors may be arranged such that there is one in each corner of the zone.

An optional mechanism for distributing the weight of an object uniformly between multiple sensors is shown in FIG. 2. Guide pin 207 and its associated keeper limit the deformation that can occur through the centre portion of upper mat 203 in zone 201, which helps to distribute the weight of any object placed on the central portion out to the sensors in that zone. It is preferred for the weight of an object to be uniformly distributed across the sensors so that accurate readings can be obtained and to simplify post-processing requirements. Each guide pin may be positioned in line with a sensor.

Suitably the different zones of the sensing pad are separate from each other so that the sensors in one zone are not activated when an object is placed on another zone. This may be achieved by arranging the sensing pad such that the upper mat in one zone does not deform (and thus activate the sensors) when an object is placed on the upper mat of a neighbouring zone. The sensing pad suitably includes one or more boundary strips between neighbouring zones. In FIG. 2 the boundary strip between zones 201 and 202 takes the form of a continuation of lower mats 204 between the two zones. The boundary strip could take the form of a different type of material from the lower mats. Indeed the boundary strip may take the form of any suitable barrier that is capable of preventing deformation in one zone of the sensing pad caused by an object being placed on that zone from being transmitted to another zone of the sensing pad.

The combination of a flexible covering 206 with a relatively non-flexible plate 205 shown in FIG. 2 is optional but may be advantageous. Having a flexible covering that compresses slightly under pressure will help the pads to be non-slip and also mean that objects can be placed quietly on the sensing pad. The covering is also suitably water resistant so that the sensing pad can be wiped clean. An example of a suitable material is silicone. The relatively inflexible plates help to transmit pressure to the sensors. They also help to distribute the weight of an object uniformly between multiple sensors in a particular zone (as explained above). Consequently they may improve the accuracy of the readings that the sensors produce. The flexible covering may be formed on the relatively inflexible plates by overmolding.

The sensing pad may also include a docking station, shown at 208 in FIG. 2. In this example the docking station includes a power source 209, a power manager 210 and a receive unit 211. The power source may be a battery and/or a connector for receiving power from an external source. The battery may be rechargeable. The receive unit is configured to receive input data from sensors in the sensing pad. These suitably include the pressure/weight sensors described above and may include other sensors comprised in the sensing pad. For example, it might be useful for the sensing pad to include sensors that can detect environmental conditions that could be relevant to any objects on the sensing pad, such as temperature, humidity or vibration.

The power manager may be configured to control power usage of the sensing pad, particularly in dependence on sensor readings being received by the receive unit. Power management is important if the sensing pad is to be able to run off a battery for long periods of time. In one example, the sensors may be configured to report only if they detect a change in weight (e.g. because an object has been removed from the sensing pad). The power management unit may be configured to cause the other components in the sensing pad to enter a power saving mode if the receive unit has not received any updates from the sensors for a predetermined length of time. The power management unit might also make use of one of the other sensors. For example, the power management unit might wake up the electrical components in the sensing pad (including possibly the weight/pressure sensors) only if a movement and/or vibration sensor detects movement in the vicinity of the pad.

The sensing pad is suitably associated with a controller, which is where the intelligence of the system resides. The controller can form part of the sensing pad. For example, it could form part of receive unit 211. Alternatively the controller could be implemented on another device, which is connected to the sensing pad via wired or wireless means. A further option is for the controller to be implemented by a combination of the sensing pad and one or more other devices so that the intelligence spans multiple devices.

Some or all of the controller might also be implemented by a distributed processing system, e.g. in the cloud.

An example of a controller is shown in FIG. 3. The controller, shown generally at 301, comprises an input 302 that is configured to receive information about the presence of an object on a sensing pad. It also comprises a stock control module 303, which is configured to determine which zone the detected object is located in on the sensing mat. It is also configured to associate the detected object with an object type associated with the determined zone. The controller, or some aspects of it, could be implemented in hardware but it is most likely to be implemented by a processor acting under software control.

An example of a scenario in which the controller is implemented in a separate device from the sensing pad is shown in FIG. 4. The figure shows sensing pad 401, a user device 409 and the cloud 408, all of which may be capable of uni- or bi-directional communication with each other. In this example sensing pad 401 comprises docking station 402. A limited amount of intelligence resides in the docking station in this example, so receive unit 403 is capable of receiving input sensor data and performing straightforward processing on that data—such as converting resistance measurements into voltage, for example. The docking station also comprises a wired connector 407, such as a USB port, a battery 405 and a power manager 406. The docking station could be connected to a power source or another device via the wired connector. That might enable the docking station to access greater functionality, such as more processing power or a user interface.

The docking station may be configured (as in this example) to interact with the other device or the cloud via a wireless link. The docking station comprises a wireless module 404 that is preferably capable of transmitting and/or receiving data via a suitable wireless communication protocol such as Bluetooth, Wi-Fi, GSM, LTE etc. The docking station is thus able to wirelessly upload sensor data to an external controller (whether in a smartphone, the cloud or elsewhere).

The other device is shown generally at 409. The other device is typically a user device such as a smartphone, tablet computer, P.C., laptop etc. It comprises a wireless module 410 that is capable of transmitting and/or receiving data via a suitable wireless communication protocol such as Bluetooth, Wi-Fi, GSM, LTE etc. It also comprises a user interface 411, which may include one or more of a display, keyboard, touchscreen etc.

In this example the other device 409 also comprises the controller 412. The controller includes input 413, stock control module 416 and a product database 417. The product database may include details that a user has recorded for their particular sensing pad—such as product types associated with a particular zone, number of products stored in each zone, previous weight of products in that zone and original weights of products in that zone etc. The product database may also store details of commonly used products.

The product database is shown as being part of the other device 409 in FIG. 4 but it may be stored externally of the device and accessed when needed. For example, it might be stored in the cloud. If the database is stored externally, device 409 may include a cache to store frequently accessed information locally.

The controller in FIG. 4 also includes a zone identifier 414 for associating zones with particular products and a product weight manager for processing weight measurements to produce output data in the required format.

An example of a general method for monitoring stock levels is shown in FIG. 5. The method comprises detecting an object on a surface of a sensing pad (step 501). It is then determined that the detected object is located in a particular zone of multiple zones on the surface of the sensing pad (step 502). The detected object is then associated with an object type that is associated with the determined zone (step 503).

Further examples of how the sensing pad might be used in practice are shown in FIGS. 6 to 8.

FIG. 6 covers an example method for initial set-up. In step 601 the user places the sensing pad in the required location. The sensing pad might be placed on any suitable surface, including in a cupboard, fridge or freezer. In step 602 the user connects to the sensing pad with his or her user device and starts the set-up sequence. In a typical example, the controller (or part of it) will be implemented by an app on the user's smartphone or tablet. The set-up sequence involves the user placing reference weights on each zone of the sensing pad in turn (step 603). Preferably the reference weights are placed in the centre of each of the zones so that the weight is equally divided between the sensors. Weight calibration factors entered by the user are then recorded in association with each reference weight (step 604). This may involve the user entering any or all of the information listed in steps 703 to 705 of FIG. 7 (see below).

FIG. 7 covers an example method for introducing a new item. In step 701 the user connects his or her user device to the sensing pad and starts the new item sequence. This connection might be direct or indirect. For example, in some implementations software on a user device might access the sensing pad via the cloud after initial set-up rather than directly interacting with it. The cloud would thus implement at least part of the controller and act as a repository of information and commands to be exchanged between the sensing pad and the user device. The user then selects a zone of the sensing pad for the new item (step 702). This might, for example, involve the user selecting a particular zone via a graphic of the sensing pad displayed on the user device. The user then selects from common types of packaging for the item in question (step 703). Examples might include large plastic containers, small plastic containers, large glass containers etc. The user then enters the full weight of the contents (e.g. the weight recorded on the product's packaging) (step 704). The product weight and type is then recorded for that zone of the sensing pad (step 705).

Optionally it may be possible to repeat the process of FIG. 7 if the user wants to store more than one of a particular type of product on that zone of the sensing pad.

Alternatively, the user may be queried in step 703 to enter the number of products to be stored (e.g. a number of tins or packets).

An alternative to the specific method shown in FIG. 7 would be for the user to enter an identifier for the product in question, which the controller can then use as a look-up in a database of common products stored either by the controller or elsewhere, e.g. in the cloud. The database might usefully include information such as packaging weights, full weight and weight-to-volume ratios for typical products. The controller might require the user to enter a product description, identification number or a scan or photograph of a barcode or QR-code to serve as the product identifier.

FIG. 8 covers a typical usage scenario. In step 801 motion is detected in the vicinity of the sensing pad. This triggers one or more electrical components of the sensing pad to wake up, particularly power hungry components such as the CPU of the wireless module (step 802). The receive unit then scans the sensors for any change in the weight of objects on the sensing pad (step 803). Any new weights may be calibrated using pre-programmed calibration factors (step 804). The calibrated weights are then summed across all of the sensors in the zone (step 805). The controller then performs a product look-up to determine how much of the product remains (step 806). This may involve a comparison between the new weight and the previous weight, the weight that was recorded when the item was new and/or a standard weight for that item that is accessible via a product database. Finally the new data is provided to the user or stored until required (step 807).

Data that might be provided to the user in a number of different formats:
The controller may provide the user with a remaining net weight of the product in question.
he controller may convert the remaining net weight into a volume that is dependent on the weight-to-volume ratio of the product in question.
The controller may convert the remaining net weight into a percentage or fraction of the original total remaining.
The data may be provided to the user in one format or in multiple formats.
The user may be able to select what format to receive the data in and may select different formats for different products.
The controller may determine the appropriate format in dependence on the product type (e.g. is the product of type “solid” or “liquid”?).

The controller may provide the user with updates whenever a new weight is detected, at predetermined intervals or only when the user requests an update. The data may be provided via user polling or via a push notification service, e.g. to a user's phone. This may be particularly applicable in implementations where the sensing pad uploads data to the cloud, which acts as the controller, and the cloud provides the processed data to the user's smartphone as and when required. The data might only be provided to the user when a predetermined condition has been met, e.g. the remaining amount of a particular product has fallen below a predetermined threshold.

One particularly advantageous feature of the methods and apparatus described above is that it allows the gross and net weight of specific food products to be calculated, together with the remaining volume. For example, the weight of a milk bottle might be the same as the weight of tomato ketchup but the volume of the actual food product could be very different. In most embodiments the weight sensor is only capable of generating weight data. It does not recognise the weight to volume relationship of the contents or the weight of the container. An example of a method for addressing this is shown in FIG. 9. The controller allows the user to input information that identifies the exact product (step 901), e.g. by using either a barcode scanner or Global Trade Item (GTI) number (formerly European Article Number or EAN). The controller suitably has access to a range of popular consumer products that it looks up to obtain product specific information such as weight to volume ratios and packaging weight (step 902). It can thus be set to calculate the net weight of the contents based on the measured gross weight and a stored packaging weight (e.g. the weight or the jar or bottle for that particular product) (step 903). It can also be set to calculate the remaining volume of the contents based on a stored weight to volume relationship for that particular product (step 904). This enables it to automatically calculate the volume without complicated manual user calibrations, allowing the user to clearly see an accurate remaining volume of foodstuff in question.

Another beneficial feature of the methods and apparatus described above is that it enables the user to be provided with information about products that are related to a particular product whose weight has been detected. As an example, the controller may link a product that the user has on one of their sensing pads with other foodstuffs that could be used to make a meal. Those related products might be products that the user has in stock or not. Typically the linked products would form ingredients for a recipe. The ingredient list could then be provided to the user, with an indication of which products the user already has and which might have to be purchased. The controller could also provide the user with the recipe.

Another advantageous feature of the methods and apparatus described above is that it allows additional functionality of a user device, such as a smartphone, and/or the functionality of other applications, such as If This Then That, to be combined with the functionality of the sensing pad. As an example, the controller may provide the user with alerts about products that are running low when the user's phone indicates that the user is outside a supermarket. The controller may thus only provide the user with information not only when the remaining amount of a product is below a certain threshold but also when some completely independent factor indicates that the user might be interested in receiving that information at the present moment.

The sensing pad may also be used as a weighing scales. The sensing pad may be provided with a simple display, on which it can output weight or volume measurements, or it may output the appropriate measurements to the external controller for display to the user.

The sensing pad might be used alone or incorporated in other products. For example, it is envisaged that the sensing pad might be incorporated into the base of kitchen storage containers—such as pasta jars, coffee jars, egg cups or the like—and used to monitor its contents. The other products could take the form of add-ons or accessories to the sensing mats. They could, for example, be configured to connect via a wired or wireless connection with the docking station of a separate sensing mat, rather than having a docking station of their own. Such add-on products would preferably be controlled via the same controller that controls the associated sensing mat, e.g. via an app on a user's smartphone.

The methods and apparatus described above have been primarily described with reference to a domestic setting in which they are used to help a user keep track of foodstuffs. This is just one example of a suitable application and it should be understood that the sensing pads may be used to keep track of any substance or object.

### Sound Detect

An example of a sound detect unit is shown in FIG. 10. The sound detect unit comprises a sound learning module 1001, a sound detect module 1002 and an action unit 1003. The sound detect unit may also comprise a microphone 1004. The sound learning module is configured to receive a signal indicative of a sound and associate that sound with a particular event. The sound detect module is configured to receive a signal indicative of a sound and compare it with sound signals that it has previously associated with a particular event. If the sound detect module determines that the signals are sufficiently similar to each other, it determines that the particular event has occurred and triggers the action unit to perform an appropriate action.

The sound detect unit will usually take the form of a small hub that can be placed on a kitchen worktop or mounted on a wall using a wall bracket. A more detailed example of a sound detect unit and the components it may comprise is shown in FIG. 10. The sound detect unit may have a battery, as shown, but may also be connected to mains power. The battery may be rechargeable.

The sound detect unit can be “trained” by a user to recognise particular sounds. The user is also able to set triggers and create actions so that when the sound detect unit detects a certain sound it can send a customised notification to the user or interact with other devices around the user's home. The “action” might be taken solely by the sound detect unit or might involve one or more other devices.

In one example, the sound detect unit may issue an alert to the user when it detects a sound that indicates an appliance has finished a program (e.g. the microwave has “pinged”) or a sound that indicates an appliance is not working properly (e.g. the fridge door has been left open). The sound detect unit might issue an alert by generating a sound of its own or flash a light. However, in this scenario the sound detect unit is likely to be most useful when the user is not in the vicinity of the sound detect unit (and therefore not able to hear the sound that triggered the alert in the first place). It is therefore preferred for the sound detect unit to issue act on an alert by interacting with another device that is more likely to be in the vicinity of the user, e.g. by sending a message to the user's mobile phone.

Other actions might involve the sound detect unit causing another device to perform an action. For example, the sound detect unit might control a connected oven to switch off or reduce temperature in response to the beep of a timer.

The sound detect unit might include sensors to give it increased functionality. Suitable examples include temperature, motion, light and humidity sensors. The sound detect unit could, for example, detect and manage moisture levels in the air to avoid mould and condensation. It could help ensure that food has the right environmental conditions to achieve a long shelf-life. The user may be provided with advice and suggestions on how the kitchen environment may be improved. This advice might be provided via a display on the sound detect unit, audibly via a loudspeaker or via a separate device such as a user's smartphone or similar. The sound detect unit might also incorporate a light that could emit a soft glow when a movement sensor in the device detects movement. The sound detect unit might be configured only to emit that light during hours of darkness. Activation of the light might therefore be dependent either on the time or on the output of a light sensor.

Another option is for the sound detect unit to control other connected products based on a combination of inputs. For example, if someone walks past the sound detect unit at a certain time of day, e.g. between 6 am and 9 am, and this is detected by the sound detect unit's motion sensor, the sound detect unit may control a connected kettle to switch on.

The sound detect unit might control other connected devices directly, e.g. by sending them simple commands such as “turn on” or “turn off” via a wireless link. The sound control unit might also control other devices indirectly, e.g. the sound detect unit may inform an external controller, such as a smartphone app, that the appropriate trigger conditions have been fulfilled and the external controller might directly control the other connected device to perform the required action.

The external controller may be similar to the controller described above with reference to the sensing pad. The stock control unit described above might be replaced by a combination of an action control module for identifying trigger conditions and initiating the appropriate action and an external device controller for interacting with other devices. Again, although the external controller could be implemented wholly or partly in hardware it is likely to be implemented predominantly by a processor acting under software control. At least all or part of the controller might be implemented by a user device, the cloud or a combination of the two. The user device may be a smartphone, tablet, laptop or the like. In many implementations, at least part of the controller is likely to be a smartphone running an app.

Preferably the sound detect unit incorporates a wireless module that is capable of transmitting and/or receiving data via a suitable wireless communication protocol such as Bluetooth, Wi-Fi, GSM, LTE etc.

The user may be able to interact directly with the sound detect unit to program the appropriate triggers and actions. The sound detect unit might include a user interface to enable the user to program it. Alternatively the user may program the sound detect unit through an external controller, which may be connected to the sound detect unit via a wired or wireless connection. In one preferred example, control and programming of the sound detect unit may be possible via a combination of the sound detect unit itself and an external controller. For example, the sound detect unit may be provided with a simple user interface, such as a single button, to facilitate learning of sounds. The user may then program the appropriate actions via an app on his or her smartphone. The user may then receive notifications and/or advice based on what the sound detect unit is detecting via the same app (or other external controller).

The sound detect unit may “learn” sounds continuously. For example, it might stream sound to a user's phone whenever it detects a sound that it does not recognise so that the user can identify the sound and associate it with any appropriate triggers. The sound detect unit may also have a “learning mode” when the user deliberately introduces it to sounds that the user wants it to recognise. An example of a learning process is shown in FIG. 11 for an example scenario in which the sound detect unit is controlled by a smartphone app. The learning mode is useful because it enables the user to introduce the sound detect unit to sounds that might occur rarely in the normal course of events—such as the noise the freezer makes when its door is left open. Likewise, the ability to learn continuously is useful because it avoids the user having to pre-program every noise that the sound detect unit might encounter. Preferably the sounds detect unit is able to implement both forms of learning.

An example of a typical use process for the sound detect unit is shown in FIG. 12. The sound recognition process may be based on a Fourier transform technique that monitors sound patterns over frequency and time. Very low and very high frequencies may be removed as being: (i) not of interest; and (ii) a potential source of spurious noise. The sound detect unit may use an optimised look up table for sound matching.

### Fridge Camera

An example of a fridge camera and methods of operating it are shown in FIGS. 14 to 17.

The fridge camera is a wireless camera that takes a picture of the contents in a user's fridge upon the fridge door being opened or closed. Suitably the camera includes a light sensor and/or motion sensor to detect opening or closing of the fridge door. The device suitable operates in sleep mode until it senses light and/or motion. This automatically triggers the camera to take a picture upon a forwards y-axes motion.

The fridge camera may use high-speed sampling of a 1-axis accelerometer to calculate the relative location of the camera, based upon the understanding that: (i) distance equals speed multiplied by time; and (ii) that the camera is attached to a fixed hinge. From this information it will take a picture of the fridge only when the camera is moving in the correct direction and as it passes the optimal selected location. When the fridge door is closed, accelerometer positioning is reset, avoiding any cumulative drift in readings.

The fridge camera may take several images during this time and use image recognition to ensure that the full height and width of the fridge and its contents are captured.

A fridge camera can also be placed inside of the fridge to capture the contents in the fridge door. This second camera may sync with the camera fitted to the door to know when to capture the image.

Any of the devices described herein may interact with each other. They may also be used for any suitable application and are not limited to use in kitchens or other domestic settings.

At least some of the structures shown in FIGS. 1 to 5 (and indeed any other block apparatus diagrams included herein) are intended to correspond to a number of functional blocks in an apparatus. This is for illustrative purposes only. The figures are not intended to define a strict division between different parts of hardware on a chip or between different programs, procedures or functions in software. In some embodiments, some or all of the algorithms described herein may be performed wholly or partly in hardware. In many implementations, at least the controller, zone identifier and product weight manager will be implemented by a processor acting under software control. Any such software is preferably stored on a non-transient computer readable medium, such as a memory (RAM, cache, hard disk etc) or other storage means (USB stick, CD, FLASH, ROM, disk etc).

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A sensing pad configured to detect an object on a surface of the pad, said surface being configured into multiple zones, and determine in which zone the detected object is located in order that the detected object can be associated with an object type that is associated with the determined zone.

2. A sensing pad as claimed in claim 1, the sensing pad being associated with a controller that is configured to associate the detected object with the object type.

3. A sensing pad as claimed in claim 2, comprising the controller.

4. A sensing pad as claimed in claim 2, comprising a wireless transmitter, the sensing pad being configured to transmit data indicative of a detected object to the controller.

5. A sensing pad as claimed in claim 1, configured to at least one of:
transmit data comprising one or more of an indication of the presence of the detected object, a weight of the detected object and the determined zone in which the detected object is located; and
detect when the presence of an object on the surface of the pad changes and to enter a low power mode if no changes occur for a predetermined length of time.

6. (canceled)

7. A sensing pad as claimed in claim 1. comprising a sensor configured to detect movement in the vicinity of the sensing pad, the sensing pad being configured to wake from a low power mode if the sensor detects movement.

8. A sensing pad as claimed in claim 1, comprising at least one presence sensor associated with each zone, the sensing pad being configured such that a presence sensor associated with one zone detects an object located in that zone but does not detect an object located in any of the other zones.

9. A sensing pad as claimed in claim 1, comprising an upper mat and a lower mat, the sensing pad comprising at least one of:
one or more presence sensors between the upper mat and the lower mat for detecting an object on the surface of the pad;
one or more guiding pins between the upper mat and the lower mat configured to assist the upper mat to deform uniformly across its surface responsive to an object on that surface; and
one or more boundary strips that separate an upper mat of one zone from an upper mat of a neighbouring zone.

10. (canceled)

11. (canceled)

12. A sensing pad as claimed in claim 9, wherein the one or more boundary strips are configured to prevent the upper mat of one zone from deforming responsive to an object on its neighbouring zone.

13. A sensing pad as claimed in claim 9, at least one of the upper and lower mats comprising a flexible material and/or an inflexible plate.

14. (canceled)

15. A sensing pad as claimed in claim 1, comprising one or more weight sensors configured to detect the weight of an object on the surface of the pad.

16. A sensing pad as claimed in claim 15, the weight sensors being configured to output a detected weight for being converted into a volume,

17. A controller comprising:
an input configured to receive data indicative of an object detected on a sensing pad; and
a stock control module configured to determine which zone, of multiple zones on the surface of the sensing pad, the detected object is located in and associate the detected object with an object type associated with the determined zone.

18. A controller as claimed in claim 17, the stock control module being configured to determine a remaining amount of a comestible in dependence on the received data and the object type associated with the detected object.

19. A controller as claimed in claim 18, configured to provide an indication of the remaining amount to a user:
in dependence on that remaining amount and/or a factor independent of the remaining amount: and/or
in a format that is dependent on user preference.

20. (canceled)

21. A controller as claimed in claim 17, the stock control module being configured to at least one of:
convert the received data into data of a different type in dependence on the object type associated with the detected object; and
determine the object type in dependence on one or more of user input, a product identification number, or a scan of an identification image marked on the object.

22. (canceled)

23. A controller as claimed in claim 17, wherein the received data includes data indicative of at least one of:
a weight of the detected object, the stock control module being configured to convert that weight into a volume in dependence on the object type associated with the detected object; and
a gross weight of the detected object, the stock control module being configured to convert that gross weight into a net weight in dependence on the object type associated with the detected object.

24. (canceled)

25. A controller as claimed in claim 17, wherein the stock control module is configured to identify a set of one of more object types linked to the object type with which the detected object is associated and provide that set of object types to a user.

26. A controller as claimed in claim 25, wherein the set of one or more object types correspond to ingredients in a recipe.

27. A method comprising:
detecting an object on a surface of a sensing pad;
determining that said object is located in a particular zone of multiple zones formed from the surface of the sensing pad; and
associating the object with an object type associated with the determined zone.

28-34. (canceled)
